(19) United States
(12) Patent Application Publication
(10) Pub. No.: US 2020/0115559 A1
(43) Pub. Date: Apr. 16, 2020

(54) METHOD OF IMPROVING STAIN RESISTANCE OF SURFACES

(71) Applicant: FP-Pigments, Espoo (FI)

(72) Inventors: Sami Haakana, Espoo (FI); Jorma Viitanen, Espoo (FI)

(21) Appl. No.: 16/499,888

(22) PCT Filed: Apr. 3, 2018
(86) PCT No.: PCT/FI2018/050241

§ 371 Date: Oct. 1, 2019

(30) Foreign Application Priority Data
Apr. 2, 2017 (FI) 20175305

(51) Int. Cl. C09D 5/00; C09D 7/61; C09D 7/40; C09D 127/06; C04B 14/28

(52) U.S. Cl. CPC C09D 5/00; C09D 7/61; C08K 2003/265; C09D 127/06; C04B 14/28; C09D 7/67

(57) ABSTRACT

Method of increasing stain resistance of a surface of a porous layer formed by a binder and filler particles. In the surface, the filler particles are spaced apart and particles of precipitated calcium carbonate having a particle size in the range of 30 to 60 nm are incorporated into the layer in a sufficient amount to fill pores between the filler particles of the surface.

### FIELD

The present invention relates to surfaces having improved stain resistance. In particular, the present invention concerns a method of improving stain resistance of surfaces formed by binders and fillers. The present invention also concerns film forming compositions having improved stain resistance.

### BACKGROUND

Materials with porous surfaces readily take up fluids that may leave stains thereon. Such materials are, for example, concrete, grout and ceramics, as well as paint films and other porous surfaces formed by materials comprising binders and fillers.

To protect surfaces against water- and oil-based stains, various stain resistance chemicals are currently being used. Such chemicals typically contain silicon or fluorinated compounds. Examples of conventional agents include fluorinated polyurethane dispersions and fluoroalkylsilanes which aim at forming an impervious film on the surface.

Surface treatment chemicals fail to provide a permanent protection of the material, in particular if the surface is exposed to water in the form of rain, drizzle, fog and similar outdoor conditions, which rinses off the surface protection. Already for that reason, surface treatments using stain resistance chemicals need to be frequently renewed to ensure proper protection.

Furthermore, in many cases, it is undesirable to cover the surface with a uniform film, because such a film will impair breathability and trap water and humidity inside the material. This may give cause to microbial growth, such as moulding, on and inside the material.

There is a need for achieving prolonged protection of surfaces formed by materials comprising binders and fillers.

### SUMMARY OF THE INVENTION

It is an aim of the invention to remove at least a part of the problems relating to the known technical solutions and to provide a method of increasing stain resistance of a porous surface formed by a binder and filler particles.

It is another aim of the invention to provide a novel film-forming composition comprising a binder and mineral fillers.

Further, it is still a further aim of the invention to provide stain resistant surfaces formed by mineral fillers held together with binders.

The present invention is based on the idea of providing an additive based on ultrafine precipitated calcium carbonate and incorporating that material into conventional film- or layer-forming compositions comprising binders and mineral fillers. In particular, the present invention provides an additive constituted by particles of precipitated calcium carbonate having an average particle size in the range of 30 to 60 nm. Preferably, the particles are provided in the form of a composition having a narrow particle size distribution.

Surprisingly it has been found that precipitated calcium carbonate particles of the indicated size range efficiently fill the voids or pores between larger mineral filler particles having a size of about 1 to 15 micrometers so that at loadings of about 0.1 to 7.5% by weight of the finely divided material a dense and smooth surface is obtained which is stain resistant. It would appear that the uptake of water and oil of such a surface is reduced compared with a surface which does not contain such particles, although this is merely a suggestion and not limiting of the invention.

The invention also provides compositions of binders and mineral fillers, such as paint, grout and concrete, containing 0.1 to 7.5% of precipitated calcium carbonate particles of 30 to 60 nm.

Finally, the present invention also provides stain resistant surfaces.

More specifically, the method according to the invention is mainly characterized by what is stated in the characterizing portion of claim 1.

The compositions according to the invention are mainly characterized by what is stated in the characterizing parts of claims 17 and 27, and the surfaces according to the invention by what is stated in the characterizing parts of claims 28.

Considerable advantages are obtained by the invention. Not only does the calcium carbonate of the present kind improve stain resistance without the use of fluorinated compounds, silicon compounds or other external treatment chemicals, but it also improves optical properties of the mineral layers, such as opacity. The surfaces also become more dense and harder as a result of the modification.

In contrast to conventional stain resistant increasing agents, the present particles act inherently to give an effect which will not be reduced by rain or other weather conditions. For this reason, no renewal of treatment is needed.

Next embodiments will be examined in more detail with reference to the attached drawings.

### BRIEF DESCRIPTION OF THE DRAWINGS

FIG. 1 is an SEM image showing in cross-section the structure of a reference coating;

FIG. 2 is an SEM image showing in cross-section the surface structure of a coating according to an embodiment according to the present invention;

FIG. 3 is an SEM image showing the surface of the Reference coating of FIG. 1; and

FIG. 4 is an SEM image showing the surface of the embodiment of FIG. 2.

### EMBODIMENTS

### Definitions

In the present context, the term “pigment volume concentration”, abbreviated PVC, stands for the amount pigment in a coating compared to amount of binder. In general, as the PVC increases the gloss and durability of the coating decreases. Also, the porosity of the surface increases that leads to a decrease in stain resistance.

“Critical PVC” designates the point (numerical value of the PVC) at which the binder of the coating loses its ability to bind with the particles in the coating.

“Stain” typically stands for a discoloration of the surface of the material which, for example, can be seen, i.e. determined or assessed visually.

“Stain resistance” stands for the ability of the surface to become stained (i.e. to pick up, for example, by chemical or physical interaction discolouring substances which leave stains on the surface).

As briefly discussed above, provided are methods of increasing stain resistance of a surface of a material layer formed by a binder and filler particles, in particular mineral filler particles. The binders are formed by polymeric compounds that, for example, may cross-link during drying to give a polymeric network which stiffens the compositions and bonds the filler particles together. The binders may also be based on hydraulic binder materials which harden due to a chemical reaction.

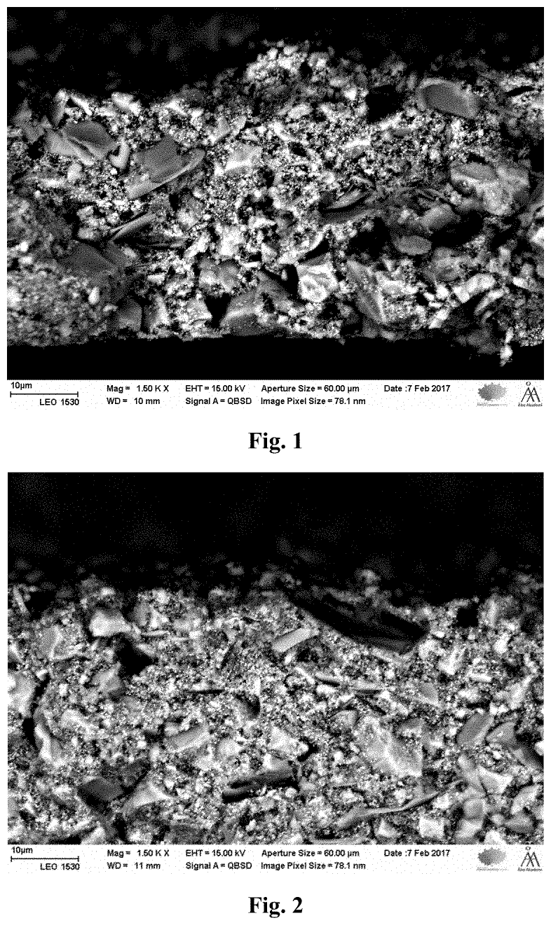

Irrespective of the mechanism, the surfaces of the materials will be porous (FIGS. 1 and 3). There are several reasons: First, the particles used typically have a size in the range of about 1 to 50 μm, in particular about 1 to 15 μm, in paints. In grout and concrete, the ballast has even much larger particle sizes. As a result, there will always be some voids and spaces about the filler particles and between filler particles. Second, when the proportion of fillers to binder increases, i.e. when the PVC-value increases, there will be more and more voids and spaces around the filler particles, giving rise to porosity in the surfaces of articles and layers formed from the hardening materials. Third, a further source of porosity is the air content present. This is partly due to the mixing operation needed to evenly distribute the mineral fillers inside the binder phase, optionally when working in a liquid, such as water or a solvent. Typically, the amount of air in grout and cement can be up to 1 to 10% by volume. For paints, the concentration of air is somewhat smaller, but still not insignificant.

For the sake of order it should be noted that the above explanations are provided for illustrative purposes only, and the present invention is not to be understood to be limited to any of them.

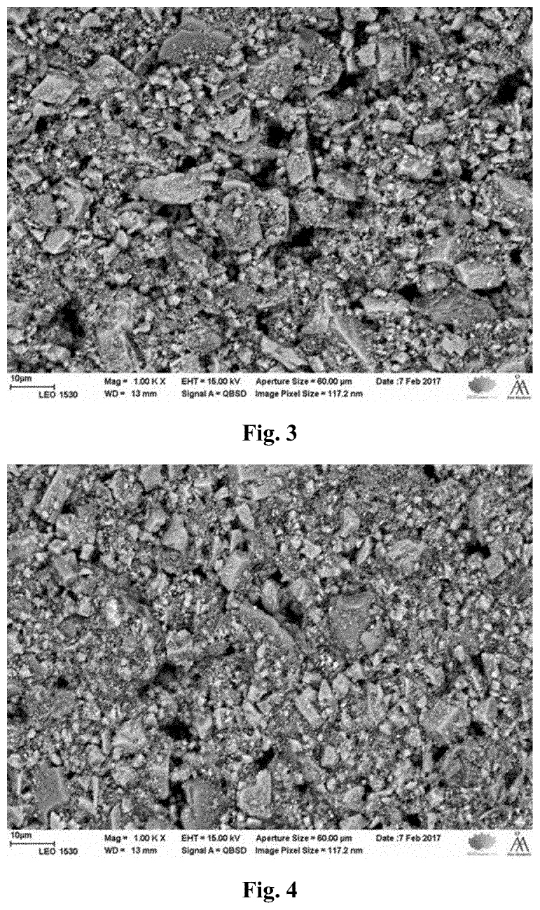

In one embodiment, there will be a plurality of voids or spaces having a size at least roughly corresponding to the sizes of the mineral fillers in the surface layers. By incorporating into the film- or surface-forming compositions, before the compositions are formed into a layer or hardened, or both, particles of precipitated calcium carbonate having a particle size in the range of 30 to 60 nm, the voids or spaces between and about the mineral fillers can be filled at least partially so as to achieve a smooth, and as it appears hard and non-absorbent surface (FIGS. 2 and 4). To that end, the amount of such precipitated calcium carbonate, also referred to as ultrafine precipitated calcium carbonate (in the following “UFPCC”), is sufficient to fill at least a portion of the spaces between the filler particles of the surface. In one embodiment, ultrafine precipitated calcium carbonate particles are incorporated in an amount sufficient to fill at least 10%, in particular 20 to 90%, for example 25 to 80%, by volume of the spaces between the filler particles.

In one embodiment, ultrafine precipitated calcium carbonate particles are incorporated in amounts of at least 0.1%, preferably 0.5 to 10%, for example 0.75 to 7.5%, in particular 1 to 7%, such as 2 to 6%, by weight of the dry matter of the composition. Thus, at loadings which are only up to 20% at the most, of the weight of the mineral fillers, the present small UFPCC particles will smoothen out the surfaces of the material layers and improve surface properties significantly.

In one embodiment, the present composition is a paint composition which contains filler particles at a concentration exceeding the critical pigment volume concentration. In particular the concentration of filler particles exceeds the critical pigment volume concentration with at least 5%, in particular at least 10%.

In one embodiment, the composition is a paint composition containing filler particles at a concentration of at least 50%, in particular at least 60%, for example more than 70%, by weight of the dry matter of the composition.

Thus, in some embodiments, ultrafine precipitated calcium carbonate particles having a particle size in the range of 30 to 60 nm are used, preferably on their own (i.e. alone)—in particular not mixed with other components—as additive for coatings (such as paint films), concrete or grout.

Thus, surprisingly, using the present technology, it is possible to work in a range of mineral filler loadings which is higher than conventionally used, but which will not incur the disadvantages known in the art caused by increase fragility, loss of hardness, loss of wet scrub resistance, loss of opacity and gloss or one of them, not to mention loss of stain resistance.

The present compositions can be provided by methods known per se. For example, a paint composition can be obtained by mixing together binder, fillers, optical pigments, paint additives and other components, referred to as “paint adjuvants”, and precipitated calcium carbonate particles.

In one embodiment, the mixing comprises combining 10 to 25 parts by weight of a binder, 30 to 70 parts by weight of a filler, 1 to 20 parts by weight of a pigment, optionally 1 to 10 parts by weight of paint additives and adjuvants, and 1 to 10 parts by weight of precipitated calcium carbonate particles having an average particle size of 30 to 60 nm.

For paint compositions, any conventional binder can be used. Examples include natural or synthetic polymers, in particular resins selected from the group of alkyd, acrylic, styrene acrylic, vinyl-acryl, vinyl acetate ethylene resins, polyesters, polyurethanes, epoxy resins, melamine resins, silanes or siloxanes. Generally, water-borne compositions are preferred. Thus, acrylic, styrene-acrylic, vinyl-acryl, vinyl acetate and vinyl acetate ethylene resins are considered particularly advantageous water compatible binders.

In addition to the added UFPCC particles, the paint compositions contain mineral pigments and fillers, such as titanium oxide, talc, ground or precipitated calcium carbonate, kaolin, dolomite, silicate, calcium sulphate and barium sulphate and combinations thereof.

Conventional additives and adjuvents are represented by the following (although the list is by no means exclusive): cellulosic thickener, pH control agents, wetting agents, dispersing agents, defoamers, coalescent agents, mold protection agents, preservatives, hydrophobing agents and rheology modifiers. The concentration of each of them is 0 to about 2% by weight, but typically they together amount to no more than 10% by weight, for example about 7.5% or less.

The composition of one embodiment is a paint composition which contains filler particles
in a concentration of at least 50%, in particular at least 60%, for example more than 70%, by weight of the dry matter of the composition,
said concentration of filler particles exceeding the critical pigment volume concentration with at least 5%, in particular the pigment volume concentration percent is greater than 70%.

The composition of another embodiment, is a paint composition comprising, calculated from the dry matter of the composition,
10 to 25% by weight of a binder:
30 to 70% by weight of a filler;
1 to 20% by weight of an optical pigment;
optionally 1 to 10% by weight of paint additives and adjuvants; and
1 to 10% by weight of precipitated calcium carbonate particles having an average particle size of 30 to 60 nm.

In another embodiment, the present technology provides compositions which contain a hydraulic binder and, mixed therewith, mineral fillers. Such compositions a, for example cement mixes, mortar, plaster, grout, and concrete.

Typically, the hydraulic binder is selected from the group of cement, such as Portland cement or rapid cement, fly ash or blast furnace slag or other pozzolonic binder, and gypsum and combinations thereof.

The mineral fillers can be sand and gravel or other mineral, inert components. Typically grout, has a content of fillers having a sieved size smaller than 4 mm, whereas concrete has a content of fillers having a sieved size greater than 4 mm.

To obtain grout, plaster, mortar and cement mixes having good workability, composition is mixed with water to provide a water-to-hydraulic binder ratio greater than 0.4, in particular 0.45 to 0.60. Thus, the composition can be mixed with water to provide a concrete mix or a grout mix having a water to cement ratio greater than 0.35, in particular 0.45 to 0.60.

The porous surfaces of layers formed by the above compositions will be densified by the addition of the present ultrafine precipitated calcium carbonate particles. Densification will be seen in the stain resistance.

Typically, the surface of the layer has a stain resistance ΔL*D65 on the Gilsonite test which is at least 5% better than that of a corresponding composition having the same weight content of filler but not containing particles of calcium carbonate having a particle size in the range of 30 to 60 nm.

The surface of the layer also has an opacity which is typically about 85%, in particular better than 88% and preferably better than 90%.

Opacity can be expressed in terms of A contrast ratio which measures the transparency of the surface. The opacity increases significantly when the pigment volume concentration of the test material increases, approximately 0.5% per 1% increase in PVC.

In one embodiment of the present technology, the composition is a paint composition comprising filler particles at a concentration exceeding the critical particle volume concentration, in particular the concentration of filler particles exceeds the critical pigment volume concentration with at least 5%, in particular at least 10%, in particular the pigment volume concentration percent is over 70%.

In a preferred embodiment of a pain composition, the Brookfield viscosity (100 rpm) is 1000-6000 cP, for example 2000-3000 cP.

In the present context, the UFPCC particles are characterized as having a “diameter” of 30 to 60 nm. This is not to be taken as a positive indication that all of the particles are spherical although it is believed that at least a considerable part of them roughly meets the above given definition for spherical particles. Broadly, the term “diameter” designates that the particles have an average size in the indicated range. Typically, the smallest diameter is 20 nm.

In one embodiment, a paint composition comprises filler and binder particles, and optical pigments, wherein 1-10 wt-% of the dry matter of the particles are precipitated calcium carbonate, having a size range of 30 to 60 nm and the filler pigment volume concentration is 70% or more.

Suitable PCC particles can be produced for example as disclosed in WO2014202836, the contents of which are herewith incorporated by reference. The particle size of the UFPCC particles is given as Sedigraph Particle size. The particle size can also be confirmed as well as assessed and determined from SEM images for example of the pure nano-PCC product.

In one embodiment, the production method comprises the steps of continuously feeding calcium hydroxide as fine drops and/or particles into gas which contains carbon dioxide and which is inside a precipitation reactor, in order to carbonate the calcium hydroxide, i.e. in order to produce precipitated calcium carbonate in the precipitation reactor.

Calcium hydroxide or other suitable Ca⁺⁺ ion sources can be used as a reactive mineral substance, from which calcium carbonate is formed using carbon dioxide. Typically, calcium hydroxide is fed into the precipitation reactor as a sludge of calcium hydroxide, i.e. as calcium hydroxide dispersed in water, such as lime milk, but it can also be fed in as a calcium hydroxide solution. The material is advantageously fed into the reactor through a disintegration and spraying apparatus located in the reactor or in association with it.

In the method, a disintegration and spraying apparatus of the so-called impact mixer type can be employed. In that kind of mixer, very fine drops and/or particles are formed from the calcium hydroxide sludge or solution.

In addition to the calcium hydroxide sludge, a gas containing carbon dioxide which effects precipitation and which may be pure or nearly pure carbon dioxide, or combustion gas, or other suitable gas containing CO₂, is continuously fed into the precipitation reactor.

In order to produce the small particles desired it is advantageous to arrange for precipitation to take place in a lowered reaction temperature, below 65° C., typically at 10-65° C., more typically at 30-65° C., most typically at a temperature below 40° C.

The dispersion of PCC particles in water will have a dry matter content of about 5 to 55%, in particular about 28 to 42%, by weight of the total mass of the dispersion.

In addition to providing, as a starting material for the present process, an aqueous dispersion of PCC particles having an average size of about 30 to 60 nm, it is also possible to provide an aqueous dispersion containing PCC agglomerates, typically having a size of 2 to 40 um, formed by primary PCC particles having an average size in the cited range of 30 to 60 nm. Such agglomerates and aqueous dispersions containing the same are disclosed in WO2014202836.

As mentioned above, embodiments will provide materials having improved stain resistance. In the present context, a stain typically is a discoloration that can be distinguished, for example by visual inspection, from the surface of the material or medium, on which it is found.

Stains can be caused by the interaction of two or more dissimilar materials. In the present case, the stain it typically caused by a material which is dissimilar from the surface formed by a binder and a filler or pigment or both. The stain will attach to such a surface by chemical or physical interactions.

The stains can be hydrophobic or hydrophilic.

Examples of hydrophobic stains include the following (the list is not exhaustive):
Gilsonite solution (stain test)
Fats and greases
The carbon compounds of exhaust gases (for example alkanes)
Lignin (at least partly hydrophobic)
Permanent markers
Blue ball pen
Pencil
Crayon
Lipstick (at least partly hydropobic)
Nicotine
Metal compounds in household water

Examples of hydrophilic stains include the following (the list is not exhaustive):
Coffee
Soya sauce
Red wine
Non permanent markers
Mustard
Ketchup

Typically, the stains are caused by the corresponding materials which primarily are hydrophobic or hydrophilic.

Next, non-limiting examples are given for illustrative purposes.

### EXAMPLES

Two different dosing levels of UFPCC have been made and results are compared to reference paint.

Tables 1 and 2 presents the measured coating properties that were analyzed from the made paint films. König hardness, water absorption, swelling and water vapor permeability analysis were conducted to the applied paint films. Table 1 shows these analysis results. Stain resistance (Gilsonite test) results are presented in Table 2.

Table 3 shows stain resistance (Gilsonite test) results and change in opacity (Δ contrast ratio) results when changing PVC from 71% up to 80% with two different dosing levels of UFPCC compared to reference paint.

Methods

Hardness was measured by the König test.

Water Vapor Permeability

Staining was assessed using the Gilsonite staining test for evaluating film porosity

In the Gilsonite staining test, the porosity of paint coatings was evaluated by analyzing the absorption of the Gilsonite solution to the coating. For the examples, a Gilsonite solution was prepared mixing together 25 g Gilsonite powder, 202.5 g white spirit and 27.5 g xylene. The paints compared were applied side by side on an application chart at a film thickness of about 100 um. The Gilsonite solution was applied at the bottom of the application chart, which was placed on a level surface, with a single horizontal brush stroke. After application of the solution it is allowed to absorb to the coating for 15 seconds. After that time, the stained area was rinsed with white spirit and after all loose stain had been rinsed off, the chart was dried.

Gilsonite staining was analyzed by visual evaluation and instrumentally.

### Example 1

Use of discrete ultrafine CaCO₃ as an additive in high PVC masonry paint leads to dense film that absorbs less water and it's harder. Paints' stain resistance is improved and it has also lower water vapor permeability. Observed changes are a function of the UFPCC dose applied: higher UFPCC dosages will lead to a harder or denser film that has better staining resistance.

TABLE 1
High PVC masonry paint - surface property results

| | | | | with 2.5% | with 5% |
|---|---|---|---|---|---|
| | | unit | REF Paint | UFPCC | UFPCC |
| König Hardness | 1 d | s | 27 | 30 | 31 |
| | 14 d | s | 30 | 33 | 34 |
| Water absorption | | % | 11 | 7 | 6 |
| Swelling | | % | 4 | 2 | 1 |
| Water Vapor | 1 d | g/(m2d) | 625 | 544 | 441 |
| Permeability, | 2 d | g/(m2d) | 571 | 500 | 405 |
| ANO R-127 | 3 d | g/(m2d) | 564 | 489 | 397 |
| | 4 d | g/(m2d) | 562 | 488 | 397 |
| | 7 d | g/(m2d) | 539 | 469 | 383 |
| | AVG | g/(m2d) | 572 | 498 | 405 |

TABLE 2
Stain resistance (Gilsonite test)
results from high PVC masonry paint

| | STAINING (L*D65) | | | |
|---|---|---|---|---|
| | Before | After | Δ | Improvement |
| Reference | 94.4 | 87.0 | −7.4 | na |
| 2.5 wt % UFPCC | 94.4 | 91.1 | −3.2 | 4.2 |
| 5.0 wt % UFPCC | 94.3 | 93.0 | −1.4 | 6.1 |

Ultrafine CaCO₃ is also visually detected from SEM images from the high PCV masonry paint. In this respect, reference is made to the attached SEM images (FIGS. 1 to 4).

As will appear, UFPCC has created more closed coating surface (compare the surface shown in FIG. 4 to the reference surface of FIG. 3), and it is also seen from a comparison of FIGS. 1 and 2 that UFPCC has been distributed evenly through the coating layer.

TABLE 3
Stain resistance (Gilsonite test) and opacity (Δ Contrast
ratio) results obtained for various PVC masonry paints

| | STAINING (L*D65) | | | Staining | Δ |
|---|---|---|---|---|---|
| | Before | After | Δ | improvement | Contrast ratio |
| Reference, PVC | 93.99 | 89.45 | −4.54 | na | na |
| 71% | | | | | |
| 5% UFPCC, | 93.9 | 91.79 | −2.11 | 2.4 | −0.67% |
| PVC 71% | | | | | |
| Reference, PVC | 93.9 | 88.49 | −5.41 | na | na |
| 71% | | | | | |
| 5% UFPCC, | 94.04 | 90.09 | −3.95 | 1.5 | 1.37 |
| PVC 74% | | | | | |
| Reference, PVC | 93.95 | 88.84 | −5.11 | na | na |
| 71% | | | | | |
| 5% UFPCC, | 94.42 | 89.76 | −4.66 | 0.5 | 2.69 |
| PVC 77% | | | | | |
| Reference, PVC | 93.91 | 88.5 | −5.41 | na | na |
| 71% | | | | | |
| 5% UFPCC, | 94.55 | 89.02 | −5.53 | −0.1 | 5.63 |
| PVC 80% | | | | | |

Surprisingly, the results of this test show that the porosity was decreased significantly as the stain resistance is increased together with the opacity. The level of porosity stayed the same even though the PVC increased up to 9% while still increasing the opacity.

### Example 2

Commercial grout was purchased where UFPCC was intentionally added through vigorous mixing. A drawdown was made and staining resistance (Gilsonite test) was conducted. The results are presented in Table 4.

TABLE 4
Stain resistance (Gilsonite test) results from grout

| | STAINING (L*D65) | | |
|---|---|---|---|
| | Before | After | Δ |
| Reference | 90.1 | 60.6 | −29.5 |
| 5 wt % | 92.0 | 68.6 | −23.4 |
| UFPCC | | | |

| | |
|---|---|
| Improvement | 6.1 |

As will appear from the results, UFPCC has improved staining resistance for the commercial grout.

### Example 3

Concrete was made as described in Table 4. Wet concrete was dried into a 15 cm cubicle and staining resistance (Gilsonite test) was made to dried concrete surface (Tables 5 and 6).

TABLE 5
Concrete recipe

| Cement | 350 kg/m\hat{ }3 |
|---|---|
| Filler | 9% |
| Sand | 50% |
| Crush 6-16 mm | 41% |
| Flow aid | 0.7% |
| water/cement ratio | 0.5 |
| UFPCC dose at trial | 1% |

TABLE 6
Stain resistance (Gilsonite test) results from concrete

| | STAINING (L*D65) | | |
|---|---|---|---|
| | Before | After | Δ |
| Reference | 69.0 | 58.31 | −10.7 |
| 1 wt % | 67.0 | 57.3 | −10.1 |
| UFPCC | | | |

| | |
|---|---|
| Improvement | 0.5 |

As will appear, an addition of UFPCC at a concentration of 1% by volume improved staining resistance for the concrete.

The following clauses represent embodiments:

1. A paint composition which contains filler particles in a concentration of at least 50%, in particular at least 60%, for example more than 70%, by weight of the dry matter of the composition, said concentration of filler particles exceeding the critical pigment volume concentration with at least 5%, in particular the pigment volume concentration percent is greater than 70%, and said composition in addition containing precipitated calcium carbonate particles having a particle size in the range from 30 to 60 nm.

2. The paint composition of clause 1 comprising, calculated from the dry matter of the composition,
10 to 25% by weight of a binder:
30 to 70% by weight of a filler;
1 to 20% by weight of an optical pigment;
optionally 1 to 10% by weight of paint additives and adjuvants; and
1 to 10% by weight of precipitated calcium carbonate particles having an average particle size of 30 to 60 nm.

3. A composition comprising a hydraulic binder and, mixed therewith, mineral filler, said composition further containing precipitated calcium carbonate particles having a particle size in the range from 30 to 60 nm.

4. The composition according to clause 3, wherein the composition contains 1 to 10% by weight of the dry matter of the composition of precipitated calcium carbonate particles having an average particle size of 30 to 60 nm.

5. The composition according to clause 3 or 4, which is selected from cement mixes, mortar, plaster, grout, and concrete.

6. A layer formed from a composition according to any of clauses 1 to 5, said layer having a surface with a stain resistance ΔL*D65 on the Gilsonite test which is at least 5% better than that of a corresponding composition which does not contain particles of calcium carbonate having a particle size in the range of 30 to 60 nm.

7. Use of ultrafine precipitated calcium carbonate particles having a particle size in the range of 30 to 60 nm, in particular as such, as additives for coatings (such as paint films), concrete or grout for improving stain resistance in particular of their surfaces.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present additive of ultrafine calcium carbonate can be used for achieving a dense film that absorbs less water and is harder as the structure is less porous. This leads to the film having better stain resistance and lower water vapor permeability.

Paints, concrete, grout and plaster and mortar surfaces are particularly interesting applications.

### ACRONYMS LIST

PVC Pigment volume concentration
UFPCC Ultra Fine Precipitated Calcium Carbonate
D65 Standard illuminant
ΔL* Difference in luminance

### CITATION LIST

### Patent Literature

WO2014202836

1. A method of providing stain resistance to a surface layer comprising:
forming a composition comprising a binder and filler particles, said filler particles being spaced apart from one another and defining spaces therebetween,
before the composition is formed into the surface layer, incorporating precipitated calcium carbonate particles having a particle size in a range of 30 to 60 nm into the composition in an amount effective to fill at least a portion of the spaces between the filler particles; and
forming t surface layer from the composition with the incorporated precipitated calcium carbonate particles.

2. (canceled)

3. The method according to claim 1, wherein said precipitated calcium carbonate particles are incorporated in an amount of at least 0.1% by weight of a dry matter of the composition.

4-5. (canceled)

6. The method according to claim 1, wherein the composition is a paint composition obtained by mixing together 10 to 25 parts by weight of the binder, 30 to 70 parts by weight of the filler particles, 1 to 20 parts by weight of a pigment, optionally 1 to 10 parts by weight of paint additives and adjuvants, and 1 to 10 parts by weight of the precipitated calcium carbonate particles having an average particle size of 30 to 60 nm.

7. The method according to claim 6, wherein the binder comprises a resin selected from the group consisting of alkyd, acrylic, styrene acrylic, vinyl-acryl, vinyl acetate ethylene resins, polyesters, polyurethanes, epoxy resins, melamine resins, silanes, and siloxanes.

8. The method according to claim 6, wherein the composition is a paint composition, in which the pigment or filler particles are selected from the group consisting of titanium oxide, talc, ground or precipitated calcium carbonate, kaolin, dolomite, silicate, calcium sulphate, barium sulphate, and combinations thereof.

9. (canceled)

10. The method according to claim 1, wherein the paint composition comprises one or more of a member selected from the group consisting of a cellulosic thickener, a pH control agent, a wetting agent, a dispersing agent, defoamer, a coalescent agent, mold protection agents, preservatives, hydrophobing agents and rheology modifiers.

11. The method according to claim 1, wherein the binder comprises a hydraulic binder and the filler particles comprise mineral fillers, wherein the hydraulic binder is selected from the group consisting of cement, fly ash, blast furnace slag, a pozzolonic binder, gypsum, and combinations thereof.

12. (canceled)

13. The method according to claim 1, wherein the filler particles comprise a sieved size greater than 4 mm.

14. The method according to claim 1, wherein the filler particles comprise a sieved size smaller than 4 mm.

15. The method according to any of claim 11, wherein composition is mixed with water to provide a water-to-hydraulic binder ratio greater than 0.4.

16. (canceled)

17. A surface-layer forming composition comprising a mixture of a binder, filler particles, and precipitated calcium carbonate particles having a particle size in a range of 30 to 60 nm, said composition being capable of forming a layer with a surface of defined by fillers which are spaced apart and define spaces therebetween, wherein the precipitated calcium carbonate particles are provided in an amount effective to fill at least a portion of the spaces between the filler particles.

18. The composition according to claim 17, comprising said precipitated calcium carbonate particles in an amount of 0.5 to 10%, by weight of a dry matter of the composition.

19. The composition according to claim 17, wherein the composition is a paint composition, and wherein the filler particles comprise:
in a concentration of at least 50% by weight of a dry matter of the composition, and
wherein said concentration of filler particles exceed a critical pigment volume concentration of the paint composition by with at least 5%.

20. The composition according to any of claim 17, wherein the composition is a paint composition comprising, calculated from a dry matter of the composition:
10 to 25% by weight of the binder:
30 to 70% by weight of the filler particles;
1 to 10% by weight of an optical pigment;
optionally 1 to 10% by weight of paint additives and adjuvants; and
1 to 10% by weight of the precipitated calcium carbonate particles having an average particle size of 30 to 60 nm, in an amount effective to fill at least a portion of the spaces between the filler particles; and.

21-22. (canceled)

23. The composition according to claim 17, wherein the binder comprises a hydraulic binder and wherein the filler particles comprise mineral fillers, wherein the hydraulic binder is selected from the group consisting of cement, fly ash, blast furnace slag, a pozzolonic binder, gypsum, and combinations thereof.

24. (canceled)

25. The composition according to claim 23, wherein the filler particles comprise ballast selected from sand, gravel, or mixtures thereof.

26. (canceled)

27. A paint composition comprising, calculated from a dry matter of the composition:
30 to 70% by weight filler particles, wherein the filler particles are spaced apart from one another and define spaces therebetween,
10 to 25% by weight of a binder,
1 to 10% by weight an optical pigment,
optionally 1 to 10% by weight of paint additives and adjuvants; and
1-10% by weight of precipitated calcium carbonate particles having a size range of 30 to 60 nm;
wherein the precipitated calcium carbonate particles fill at least a portion of the spaces between the filler particles.

28. A surface layer formed by a hardened mixture of the composition of claim 17.

29. (canceled)

30. The surface according to claim 28, wherein said surface layer is a layer of paint, grout, or concrete.

31. The surface according to claim 28, wherein the surface layer has a stain resistance ΔL*D65 on the Gilsonite test which is at least 5% better than that of a corresponding composition having a same weight content of filler particles, but not containing the precipitated calcium carbonate having a particle size in the range of 30 to 60 nm.
